(19) United States
(12) Patent Application Publication
(10) Pub. No.: US 2024/0210728 A1
(43) Pub. Date: Jun. 27, 2024

(54) CONFIGURABLE ARM TIP

(71) Applicant: Apple Inc., Cupertino, CA (US)

(72) Inventors: Alison B. Schutzberg, San Francisco, CA (US); Austin S. Young, Sunnyvale, CA (US); John Raff, Menlo Park, CA (US); Kristine S. Atom, Sunnyvale, CA (US)

(21) Appl. No.: 18/596,428

(22) Filed: Mar. 5, 2024

Related U.S. Application Data
(63) Continuation of application No. PCT/US2022/076225, filed on Sep. 9, 2022.
(60) Provisional application No. 63/261,196, filed on Sep. 14, 2021.

(51) Int. Cl. G02C 5/14; G02C 11/00; G06F 1/16

(52) U.S. Cl. CPC G02C 5/143; G02C 11/10; G06F 1/163; G02C 2200/18

(57) ABSTRACT

A wearable electronic device, including a display, and a support arm connected to the display, the support arm including a static portion connected to the display, a dynamic portion connected to the static portion, and an adjustment mechanism positioned in the dynamic portion and configured to change a thickness of the dynamic portion.

### CROSS-REFERENCE TO RELATED APPLICATION(S)

This application is a continuation of International Application No. PCT/US2022/076225, filed 09 Sep. 2022, and entitled “CONFIGURABLE ARM TIP,” which claims priority to U.S. Provisional Patent Application No. 63/261,196, filed 14 Sep. 2021, and entitled “CONFIGURABLE ARM TIP,” the entire disclosures of which are hereby incorporated by reference.

### FIELD

The described embodiments relate generally to wearable electronic devices. More particularly, the present embodiments relate to configurable arm tips for head worn electronic devices.

### BACKGROUND

Wearable electronic device, such as computer glasses or smart glasses are worn on a user's head and incorporate an optical display and computing capabilities. Computer glasses are typically supported on the user's head by support arms that are connected to either side of the glasses. With the advent of computer glasses comes an increased demand on the support arms to support the increased weight and movement of the computer glasses. Further, the inclusion of sensitive electrical components heightens the need to reduce drop events that could damage the glasses. As described herein, the support arms can include adjustable arm tips that allow for fit adjustment.

### SUMMARY

According to some aspects of the present disclosure, a wearable electronic device includes a display, and a support arm connected to the display, the support arm including a static portion connected to the display, a dynamic portion connected to the static portion, and an adjustment mechanism positioned in the dynamic portion and configured to change a thickness of the dynamic portion.

In some examples, the support arm is a first support arm, the static portion is a first static portion, the dynamic portion is a first dynamic portion, and the adjustment mechanism is a first adjustment mechanism. The wearable electronic device can further include a second support arm connected to the display, the second support arm including a second static portion connected to the display, the second static portion housing an electronic component, a second dynamic portion positioned opposite the display at an end of the second support arm, and a second adjustment mechanism positioned in the second dynamic portion and configured to change a thickness of the second dynamic portion.

In some examples, the first adjustment mechanism and the second adjustment mechanism each have a first state and a second state. A distance between the first adjustment mechanism and the second adjustment mechanism can be greater in the second state than in the first state. The adjustment mechanism can include a moveable member, a first magnet engageable with the movable member in a first state, and a second magnet engageable with the movable member in a second state.

In some examples, the adjustment mechanism includes a mechanical actuator. In some examples, the adjustment mechanism includes an electrical actuator. A proximal end of the support arm can be connected to the display, and the adjustment mechanism can be located at a distal end of the support arm. The adjustment mechanism can be bi-stable. A sensor can detect an amount of force exerted on an object by the adjustment mechanism.

According to some aspects, a support arm includes a section including an electrical component, and a movable section. The movable section can be deformable to define a radius of curvature.

In some examples, the section is substantially rigid. The movable section can include a plurality of vertebrae to maintain a minimum radius of the radius of curvature. The movable section can include a deformable wire. The movable section can include a variable volume bladder. The variable volume bladder can be adjusted using at least one of pneumatics or hydraulics.

In some examples, the support arm includes an external actuator configured to deform the movable section in response to a movement of the external actuator, the movement including at least one of rotational motion or translational motion. An inertial measurement unit can be operatively coupled to the movable section, wherein the movable section is deformable in response to a signal from the inertial measurement unit.

According to some aspects, a method for securing headwear to a head of a user includes receiving a command to tighten the headwear on the head, activating an adjustment mechanism on a support arm of the headwear, determining a force applied to the head by the support arm, and modifying a state of the adjustment mechanism in response to the force meeting a predetermined threshold.

In some examples, activating the adjustment mechanism includes modifying a density of the adjustment mechanism. The method can include transmitting the command to tighten the headwear in response to a detected motion of the headwear.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A shows a top view of wearable computer glasses.

FIG. 1B shows a perspective view of wearable computer glasses.

FIG. 1C shows a top view of an adjustable arm tip.

FIG. 1D shows a top view of the adjustable arm tip.

FIG. 2A shows a cross-sectional top view of a support arm.

FIG. 2B shows a cross-sectional top view of the support arm of FIG. 2A.

FIG. 3A shows a cross-sectional top view of a support arm.

FIG. 3B shows a cross-sectional top view of the support arm of FIG. 3A.

FIG. 4A shows a side view of a customizable support arm tip.

FIG. 4B shows a side view of a customizable support arm tip.

FIG. 5A shows a top view of an adjustable arm tip.

FIG. 5B shows a top view of the adjustable arm tip of FIG. 5A.

FIG. 6A shows a top view of an adjustable arm tip.

FIG. 6B shows a top view of the adjustable arm tip of FIG. 6A.

FIG. 7A shows a side view of an adjustable arm tip.

FIG. 7B shows a side view of the adjustable arm tip of FIG. 7A.

FIG. 8A shows a side view of an adjustable arm tip.

FIG. 8B shows a side view of the adjustable arm tip of FIG. 8A.

FIG. 9A shows a cross-sectional top view of an adjustable arm tip.

FIG. 9B shows a cross-sectional top view of the adjustable arm tip of FIG. 9A

FIG. 10A shows a side view of a customizable arm tip.

FIG. 10B shows a side view of the customizable arm tip of FIG. 10A.

FIG. 10C shows a side view of a customizable arm tip.

FIG. 11A shows a top view of an adjustable arm tip.

FIG. 11B shows a top view of the adjustable arm tip of FIG. 11A.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

Headwear, such as glasses need to accommodate to various head shapes and sizes. Finding a comfortable and secure fit can require time and effort by the user. The user often has to wear the glasses, check the fit and feel, then readjustment or replace the glasses. Traditional support arms and arm tips have limited degree of freedom and travel due to material yielding and geometrical and physical limitations. With regard to computer glasses, frame shapes are limited and the support arms require robust structure to encase electronics in small form factors, making typical glasses adjustability unfeasible. Furthermore, computer glasses require a more controlled and accurate fitting than traditional glasses due to the need to align the display eye box to the user and require clever retention mechanism due to the heavy weight of computer glasses. The disclosure herein is directed to computer glasses that incorporate adjustable support arm tips that conform to the shape and size of the user's head.

In some examples, a wearable electronic device, such as computer glasses (also referred to as “smart glasses”, “head-mounted device”, or simply “glasses”) includes lenses positioned in front of the user's eyes. The lenses can be integrated with a display unit to display visual information to the user. The lenses and display unit can be supported on the user's head by support arms position on opposing sides of the lenses and positioned to rest on or above the user's ears. In some examples, each support arm includes a static portion. The static portion can be rigid and can generally maintain its overall shape and configuration. In some examples, the static portion defines an internal volume that houses electrical components. The support arm can further include an arm tip having an adjustment mechanism. The adjustment mechanism can be movable relative to the static portion of the support arm. The shape and configuration of the adjustment mechanism can be changed in order to better secure the glasses to the user's head. For examples, the adjustment mechanism can squeeze, tighten, or press a portion of the arm tip against the user's head. In some examples, both support arms of the glasses can include an adjustment mechanism. While in other examples, only one of the support arms includes the adjustment mechanism.

The adjustment mechanism can be located at the distal end of the support arm (i.e., opposite end connected to the lenses/display). By being positioned at the distal end of the support arm, the adjustment mechanism can partially wrap around the ears or back of the head of the user.

In some examples, the adjustment mechanism includes a mechanical actuator to control the motion of the adjustment mechanism. For example, the mechanical actuator can include one or more of a knob, dial, screw, cam, or any other suitable mechanical actuator. In some examples, the adjustment mechanism includes an electrical actuator to control motion of the adjustment mechanism. For example, the electrical actuator can include one or more of an electrical motor, piezoelectric motor, solenoid, electromagnet, or any other suitable electrical actuator. As described herein, the adjustment mechanism can include a wide variety of components and features.

The adjustment mechanism can enable the arm tip to be in an extended configuration or a retracted configuration. In the extended configuration a portion of the arm tip is moved closer to the user's head than when in the retracted configuration.

There are a variety of ways that the adjustment mechanism can transition between the retracted state and the extended state. In some examples, user input can activate the transition between states. For example, a user can manually actuate the adjustment mechanism to transition to the extended state by applying a force (e.g., pushing, pressing, rotating, sliding, etc.).

In some examples, an electrical signal actuates a transition between the retracted and extended states. The signal can be transmitting in response to user input or can occur automatically upon predetermined conditions being met. In some examples, the adjustment mechanism transitions between states in response to receiving a signal from one or more sensors on the computer glasses. For example, the computer glasses can include an inertial measurement unit (IMU) that detect motion. The adjustment mechanism can activate to tighten on a user's head in response to the IMU detecting motion exceeding a predetermined threshold. In some examples, the computer glasses can include a sensor to detect when the computer glasses are place on a user's head, and the adjustment mechanism can be activated in response to detecting that the user has donned the glasses. In some examples, the act of removing the computing glasses from the user's head naturally actuates the adjustment mechanism to return to the retracted state. In some examples, a processor can determine, using force sensors, a force being applied to the head by the adjustment mechanism. In response, the processor can modify a state of the adjustment mechanism in response to the force meeting or exceeding a predetermined threshold. Modifying a state of the adjustment mechanism can include altering one or more physical characteristics of the adjustment mechanism, and/or maintaining a position or operation of the adjustment mechanism. For example, modifying a state of the adjustment mechanism can include deactivating (i.e., ceasing an operation of the adjustment mechanism). Likewise, the processor can apply additional force to the adjustment mechanism in response to detecting the force does not meet or exceed a predetermined threshold.

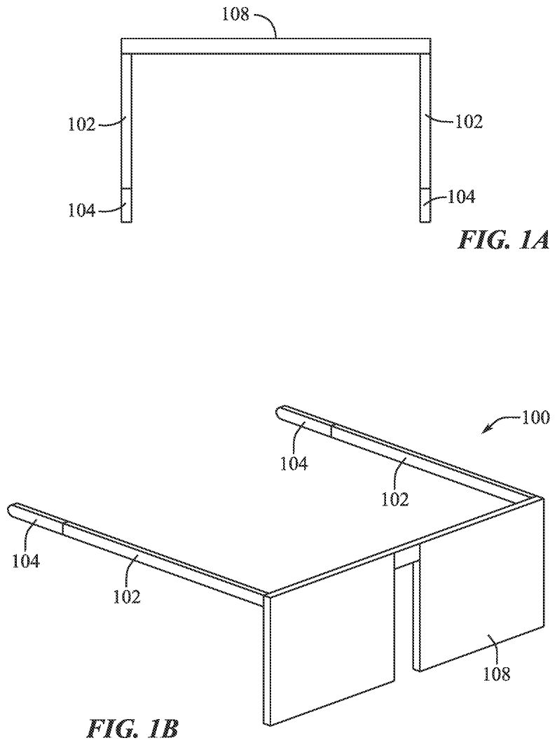

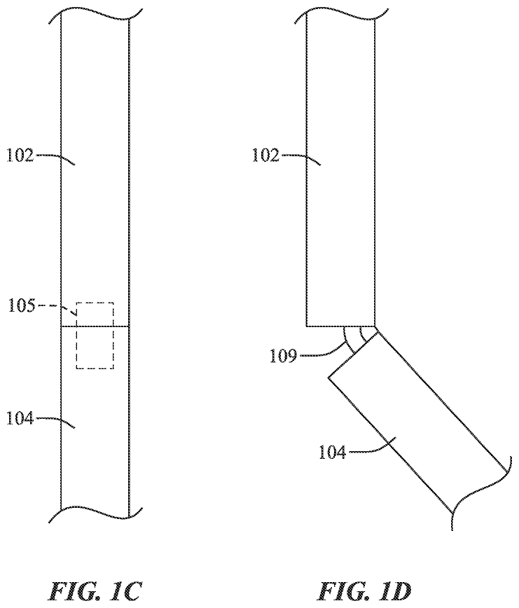

These and other embodiments are discussed below with reference to FIGS. 1A-11B. However, those skilled in the art will readily appreciate that the detailed description given herein with respect to these figures is for explanatory purposes only and should not be construed as limiting. Furthermore, as used herein, a system, a method, an article, a component, a feature, or a sub-feature comprising at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1A shows a top view of computer glasses 100, while FIG. 1B shows a perspective view of the computer glasses 100. While the embodiments depicted herein show computer glasses, it will be understood that the concepts can apply to various head-mounted devices and are not limited to “smart glasses”.

The computer glasses 100 of FIGS. 1A and 1B can include a display element 108 that is positioned in front of the eyes of a user to provide information within a field of view of the user. The display element 108 can transmit light from a physical environment for viewing by the user. The display element 108 can include optical properties, such as lenses for vision correction based on incoming light from the physical environment. Additionally or alternatively, the display element 108 can provide information as a display within a field of view of the user. The information can be provided to the exclusion of a view of a physical environment or in addition to (e.g., overlaid with) a physical environment.

In some examples, the computer glasses 100 include one or more support arms 102 that support the computer glasses 100 on the user's head. The support arm 102 can be coupled or attached to and extending from the edges of the computer glasses. The support arms 102 can house internal computing components. For example, the support arms can enclose and support various integrated circuit chips, processors, memory devices and other circuitry to provide computing and functional operations for the computer glasses 100.

The support arms 102 can wrap or extend along opposing sides of the user's head, as with a temple component. The support arms 102 can include arm tips 104 for wrapping around or otherwise engaging a user's ears and head. As discussed in greater detail herein, the arm tips 104 can include an adjustment mechanism and can be movable relative to the remainder of the support arms 102.

FIG. 1C shows a top view of the support arm 102 with an example adjustment mechanism. In some examples, the support arm 102 includes a securement feature 105 to secure an arm tip 104 in a substantially straight or coaxial position with the support arm 102. The securement feature 105 can include any number of mechanisms to removably couple the arm tip 104 to the support arm 102 (e.g., clips, snaps, magnets, fasteners, latches, etc.). The securement feature 105 can detach in response to a user pushing the arm tip 104 inward (e.g., toward the user's head).

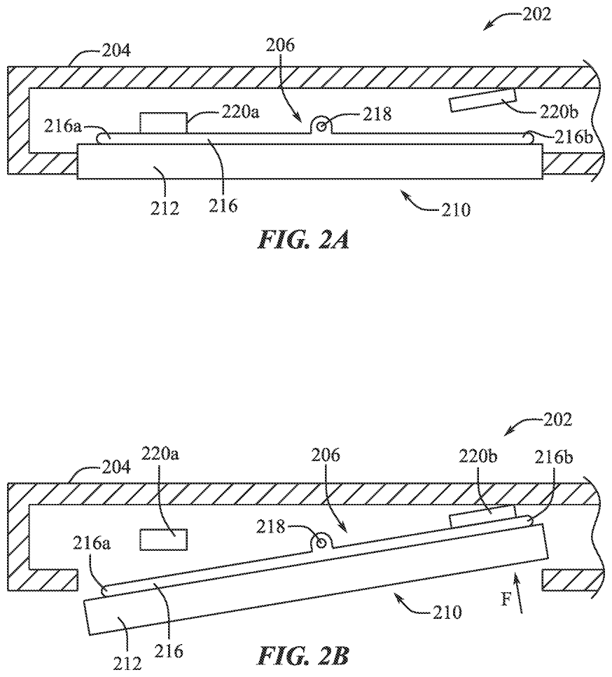

FIG. 1D shows the support arm 102 in an angled configuration in which a longitudinal axis of the support arm 102 is non-parallel with a longitudinal axis of the arm tip 104. A biasing element 109, such as a spring can exert an inward force on the arm tip 104 to press against the user's head. In some examples, the arm tip 104 can flip downward to partially wrap behind the user's ears. Further details of example adjustment mechanisms are provided below with reference to FIGS. 2A and 2B.

FIG. 2A shows a top cross-sectional view of a support arm 202 in a retracted position and FIG. 2B shows the support arm 202 in an extended position. The support arm 202 can be substantially similar to, including some or all of the features of, the support arms described herein, such as support arm 104. The support arm 202 can include an arm tip 204 that at least partially defines an external volume of the support arm 202 and further defines an internal volume 206. In some examples, electrical components are housed within the internal volume 206. The arm tip 204 can include an adjustment mechanism 210. The adjustment mechanism 210 can adjust the fitment of the support arm 202 on a head of a user. Specifically, the adjustment mechanism 210 can tighten or press against the user's head to better secure computer glasses to the user's head. In some examples, the adjustment mechanism 210 includes a cushion or pad 212 intended to physically contact the user's head. The pad 212 can be made from a silicone material. The pad 212 can at least partially define an exterior of the support arm 202.

In some examples, the adjustment mechanism 210 includes a rigid plate 216 that hinges or pivots about a pivot point 218 to change an angle of the pad 212 relative to the support arm 202. The adjustment mechanism 210 can include a first magnet 220a and a second magnet 220b. The plate 216 can be made from a material that is influenced by magnets, such that when a first end 216a of the plate 216 comes into proximity or contact with the first magnet 220a, the first end 216a is magnetically coupled or attached to the first magnet 220a. Likewise, when a second end 216b of the plate 216 comes into proximity or contact with the second magnet 220b, the second end 216b magnetically couples with the second magnet 220b.

In some examples, the adjustment mechanism 210 can be bi-stable. For example, the adjustment mechanism 210 can have a first stable state, such as a flattened or retracted state as shown in FIG. 2A, in which the first end 216a is coupled to the first magnet 220a, and a second stable state or extended state in which the second end 216b is coupled to the second magnet 220b, as shown in FIG. 2B.

In the retracted state, a longitudinal axis of the pad 212 can be substantially parallel to a longitudinal axis of the support arm 202. In some examples, the pad 212 can be substantially flush with the exterior of the arm tip 204 when in the retracted state. In some examples, the pad 212 is proud or raised relative to the exterior of the arm tip 204 when in the retracted state.

In the second stable state or extended state, the longitudinal axis of the pad 212 is non-parallel with the longitudinal axis of the support arm 202. In other words, the position of the second magnet 220b within the internal volume 206 is such that when the second end 216b of the plate 216 is coupled to the second magnet 220b, the pad 212 juts or extends outward away from the housing of the arm tip 204. This expansion can decrease a distance between the pad 212 and the user's head to provide a more secure fit on the user's head.

There are a variety of ways that the adjustment mechanism 210 can transition between the retracted state and the extended state. In some examples, user input can activate the transition between states. For example, a user can manually actuate the adjustment mechanism 210 to transition to the expanded state by applying a force (e.g., pushing, pressing, pinching or squeezing) to the second end 216b of the plate 216 toward the second magnet 220b. It will be understood that similar manual actuation can similarly actuate any number of the adjustment mechanisms described herein.

Once the force applied by the user exceeds the magnetic force of the first magnet 220a, the adjustment mechanism 210 is free to transition to the contracted state. Similarly, when in the contracted state the user can apply a force directed toward the first magnet 220a to return the adjustment mechanism to the expanded state. The second magnet 220b can configured to have a magnetic field strength that is strong enough to withstand the weight of the computing glasses (e.g., when slipping from a user's head. In some examples, the force necessary to transition between states is about 10 newton-meters.

In some examples, the adjustment mechanism 210 transitions between states in response to receiving a signal from one or more sensors on the computer glasses. For example, the computer glasses can include an inertial measurement unit (IMU) that detect motion. The adjustment mechanism 210 can active to tighten on a user's head in response to the IMU detecting motion exceeding a predetermined threshold. In some examples, the computer glasses can include a sensor to detect when the computer glasses are place on a user's head, and the adjustment mechanism 210 can be activated in response to detecting that the user has donned the glasses. In some examples, the act of removing the computing glasses from the user's head naturally actuates the adjustment mechanism 210 to return to the retracted state. It will be understood that similar automated actuation can similarly actuate any number of the adjustment mechanisms described herein.

In some examples, the first magnet 220a and the second magnet 220b are electromagnets whose magnetic force can be switched on an off. In some examples, the adjustment mechanism 210 can assume the retracted state by switching on the first magnet 220a and switching off the second magnet 220b. Similarly, the adjustment mechanism 210 can assume the extended state by switching off the first magnet 220a and switching on the second magnet 220b.

In some examples, the pivot point 218 includes a motor capable of rotational motion to pivot the adjustment mechanism 210 between the first and second stable states. The motorized pivot point 218 can be solely responsible for holding the pad 212 at a certain angle. In other words, the magnets 220a, 220b are not necessary when a motor can move and retain the pad 212 at the desired location.

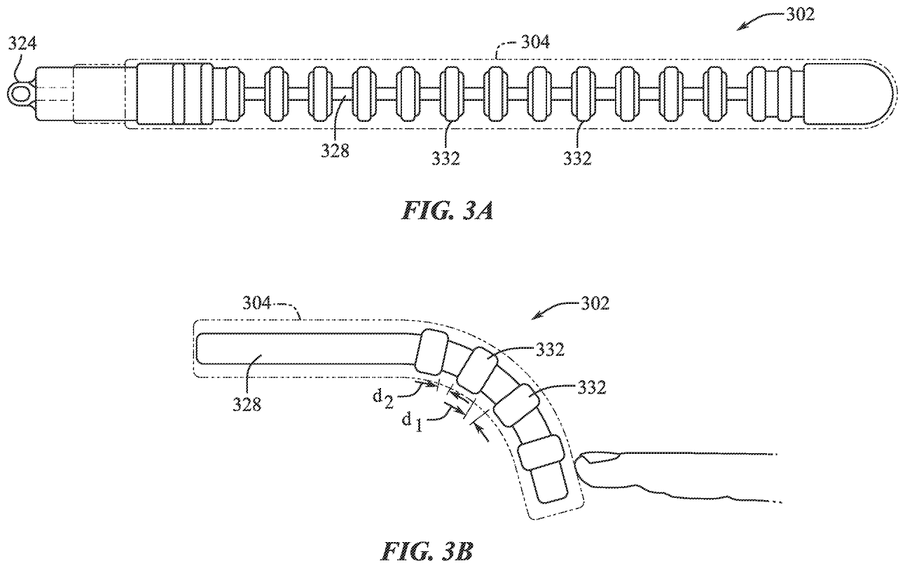

Although FIGS. 2A and 2B depict the adjustment mechanism 210 being housed at least partially within the internal volume 206 of the arm tip 204, it will be understood one or more components of the adjustment mechanism 210 can be positioned partially or entirely external to the housing of the arm tip 204. For example, the adjustment mechanism 210 can be positioned on a top wall, bottom wall, or side wall of the support arm 202. Further details of example adjustment mechanisms are provided below with reference to FIGS. 3A and 3B.

FIG. 3A shows a cross-sectional top view of a support arm 302. The support arm 302 can be designed to couple to computer glasses (e.g., using a coupler 324). In some examples, the support arm 302 represent only the arm tip or distal end of a support arm and not the entirety of the support arm. The support arm 302 can be flexible, deformable, or malleable such that a user can bend the support arm 302 into a desired shape. In some examples, the support arm 302 can include a silicone exterior surface or housing 304 that surrounds a flexible rod 328.

As is shown in FIG. 3B, the shape of the support arm 302 can be adjusted or customized by a force exerted by user's hand or finger. The material of the rod 328 can be such that the rod 328 maintains the new shape, even when the force causing a change in shape is removed. In some examples, the rod 328 is made from Nitinol. Using memory shape properties, the support arm 302 can return to its original shape after bending upon applying a condition, such as heating or applying an electrical current. In some examples, the support arm 302 can be heated above its transition temperature in order to change its shape. In some examples, the transition temperature of the support arm 302 can be around 105 degrees Fahrenheit.

A plurality of support components or vertebrae 332 can be positioned on the rod 328. The vertebrae 332 can be overmolded plastic to provide support to the rod 328. In some examples, the vertebrae 332 are placed at predetermined intervals along the rod 328 to prevent the rod 328 from being sharply bent. This reduces stress on the rod 328 caused by sharp or tight bends. For example, the vertebrae 332 can allow for a minimum radius of curvature on the rod 328 before the silicone between the vertebrae 332 compresses or the vertebrae 332 contact each other to prevent further bending. For example, as the user bends the support arm 302 a distance d₂ between two adjacent vertebrae 332 decreases until the silicone housing 304 fully compresses, causing a distance d₁ to decrease. In the manner, the support arm 304 can bend while avoiding stress caused by sharp bends. As used herein, a radius of curvature requires multiple points positioned continuously along a curve or arc defined by the arm tip. In other words, a radius of curvature cannot be created merely using two linear sections that are angled at a single point.

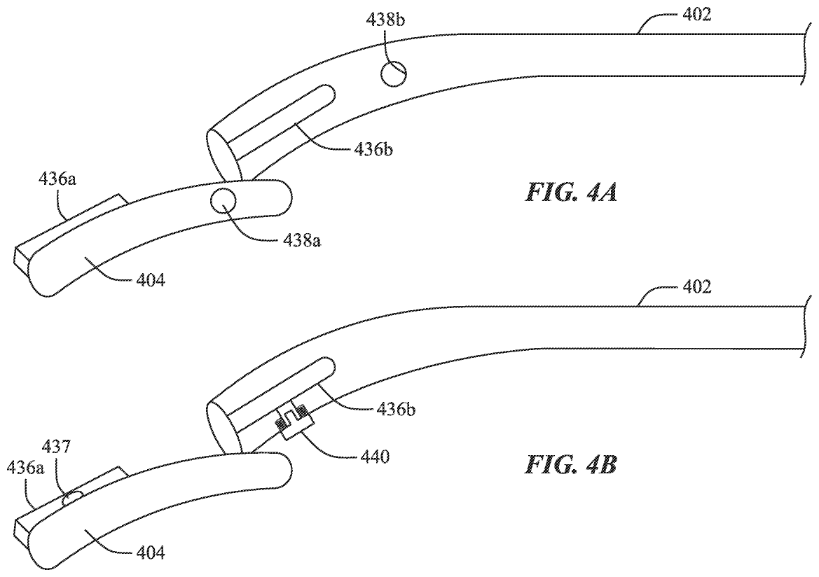

In some examples, various types of soft actuated robotic end effector designs can be implanted onto the support arms. These designs can include predesigned or pre-bend rubber structures and/or hydraulic, vacuum, or wire based structures for actuation. The robotic actuated soft arms can provide a high degree of flexibility and 3-Dimensional actuation. In some examples, electronics could be interwoven and designed within the structures. In some examples, the support arms could include force sensors or strain gauges. Users' can wear the glasses and the arms would wrap the users' head until a comfortable reaction force is detected by the sensors. Friction and wrapping force between the arms and head can distribute the weight of the computer glasses instead of supporting the weight on the ears. Further details of example adjustment mechanisms are provided below with reference to FIGS. 4A and 4B.

FIG. 4A shows a side view of a customizable support arm tip 404 designed to be attached to a support arm 402. The arm tip 404 can include a guide or rail 436a that protrudes from the arm tip 404 and is configured to slide or be inserted into a slot 436b in the support arm 402. The arm tip 404 can further include a magnet 438a configured to couple with a magnet 438b positioned on the support arm 402. The magnets 438a, 438b can be housed within or positioned externally on the arm tip 404 and support arm 402, respectively. The magnet 438a can be positioned such that when the guide 436a is fully inserted into the slot 436b, the magnet 438a is adjacent or in direct contact with the magnet 438b. The thickness, length, material, and overall shape of the arm tip 404 can be selected and customized by a user to fit according to the user's needs and preferences. In some examples, the arm tip 404 can include electrical components that assist in operation of the smart glasses. The arm tip 404 can also include electrical contacts to establish an electrical connection with the support arm 402.

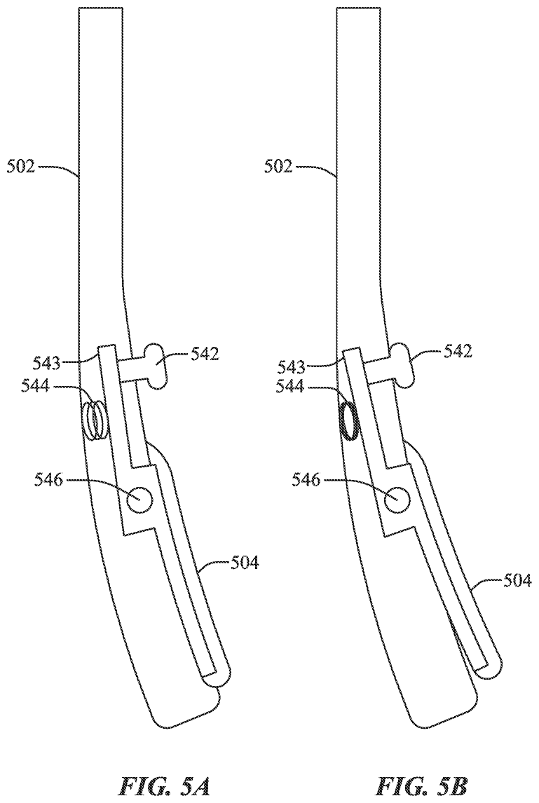

FIG. 4B shows a side view of a customizable support arm tip 404 that attaches with a support arm 402. The support arm 402 and arm tip 404 can be substantially similar to the support arm 402 and arm tip 404 described with reference to FIG. 4A. For example, the arm tip 404 can include a guide or rail 436a that protrudes from the arm tip 404 and is configured to slide or be inserted into a slot 436b in the support arm 402. In some examples, the slot 436b includes electrical contacts or connections that establish an electrical communication with the arm tip 404. The arm tip 404 can further include a button 437 configured to couple with a detent positioned in the support arm 402. The button 437 can be positioned such that when the guide 436a is fully inserted into the slot 436b, the button 437 slips into the detent to secure the arm tip 404 in position. The support arm 402 can include a release button 440 configured to release the button 437 from the detent to remove the arm tip 402 from the support arm 404. In some examples, the button 440 is an electrically activated solenoid. Further details of example adjustment mechanisms are provided below with reference to FIGS. 5A and 5B.

FIG. 5A shows a top view of a support arm 502 having an adjustment mechanism or adjustable arm tip 504 in a retracted configuration, and FIG. 5B shows the arm tip 504 in an extended position (i.e., with the arm tip 504 extended toward a user's head when being worn by a user). The support arm 502 can be substantially similar to, including some or all of the features of, the support arms described herein, such as support arm 102, 202, 302, 402.

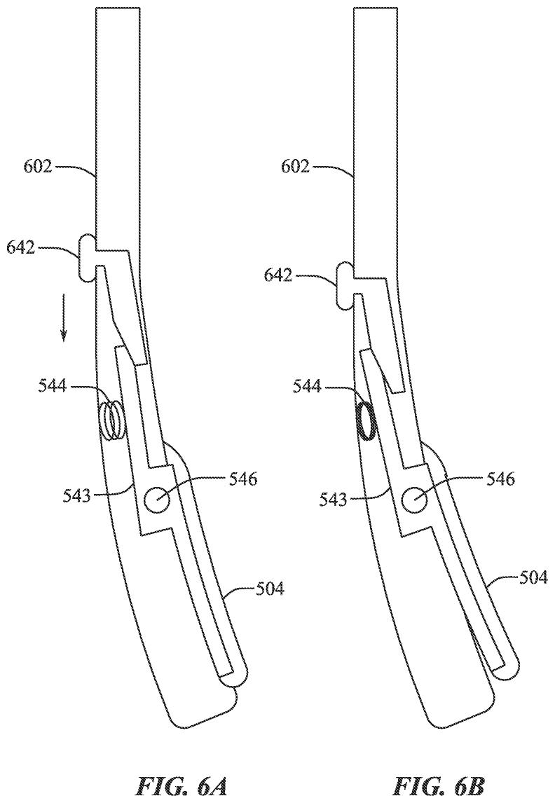

In some examples, the support arm 502 includes a dial or screw 542 that when rotated withdraws or inserts the screw out of or into the support arm 502. As the screw 542 is tightened, it presses against a swivel arm 543 causing the swivel arm 543 to pivot about a pivot point 546, causing the arm tip 504 to jut away from the support arm 502 and toward the user's head. As the screw is loosened (i.e., withdrawn from the support arm 502 a spring 544 biases the swivel arm 543 back into the retracted position with the arm tip 504 retracting away from the user's head. Actuation of the screw 542 can result from manual input by a user, or can result from electrical signals to mechanically rotate the screw 542. Further details of example adjustment mechanisms are provided below with reference to FIGS. 6A and 6B.

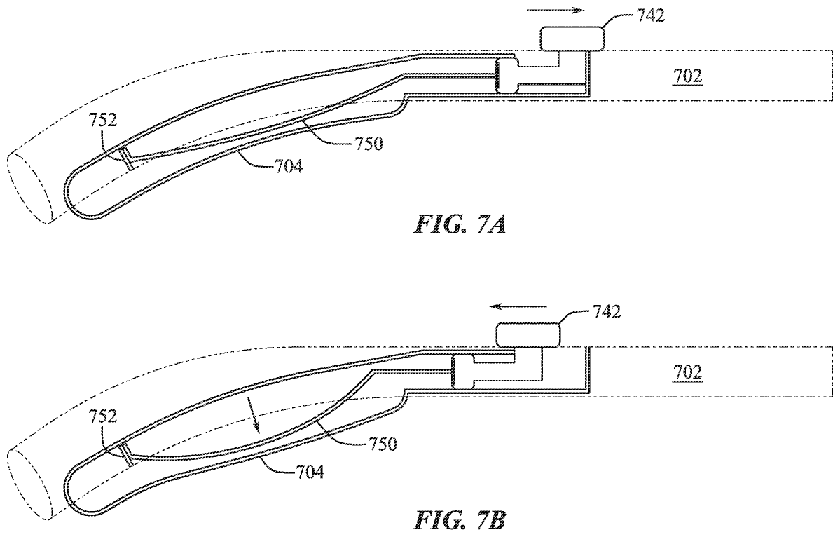

FIG. 6A shows a top view of a support arm 602 in a retracted position, and FIG. 6B shows the support arm in an extended position. The support arm 602 can be substantially similar to, including some or all of the features of, the support arms described herein, such as support arm 502. For example, the support arm 602 can include an adjustable arm tip 504, swivel arm 543 rotating about a pivot point 546 and biased by spring 544. In some examples, the support arm 602 can include a sliding cam 642 that when slide in a first direction applies a force to the swivel arm 543 to swing the arm tip 504 outward toward the user's head. When the sliding cam 642 is slid in a second, opposite direction (e.g., away from the swivel arm 543), the spring 544 biases the arm tip 504 back into the retracted position. Actuation of the sliding cam 642 can result from manual input by a user, or can result from electrical signals to mechanically drive the sliding cam 642. Further details of example adjustment mechanisms are provided below with reference to FIGS. 7A and 7B.

FIG. 7A shows a top view of a support arm 702 in a retracted position, and FIG.

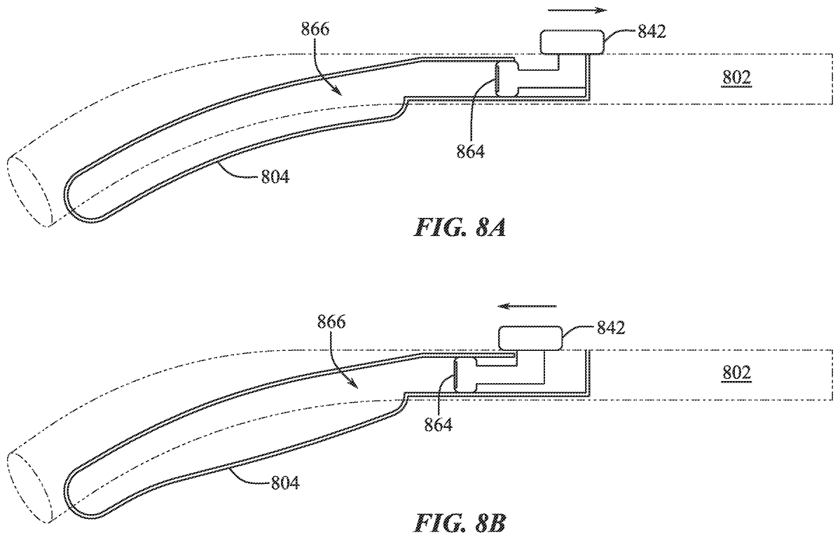

7B shows the support arm in an extended position. The support arm 702 can be substantially similar to, including some or all of the features of, the support arms described herein, such as support arm 102, 202, 302, 402, 502, and 602. The support arm 702 can include an adjustable arm tip 704 having a wire 750 that is tensioned between a stop 752 and a sliding cam 742. The sliding cam 742 can slide in a first direction to bend the wire 750 to push the arm tip 704 outward toward the user's head. When the sliding cam 742 is slid in a second, opposite direction (e.g., away from the arm tip 704, the natural shape of the wire 750 can bias the arm tip 704 back into the retracted position. In some examples, the shape of the wire 750 is modified by applying an electrical charge to the wire 750. The wire 750 can have shape memory (e.g., the wire 750 can have a first repeatable shape when an electrical charge is not applied, and a second repeatable shape when an electrical charge is applied). Actuation of the sliding cam 742 can result from manual input by a user, or can result from electrical signals to mechanically drive the sliding cam 742. Further details of example adjustment mechanisms are provided below with reference to FIGS. 8A and 8B.

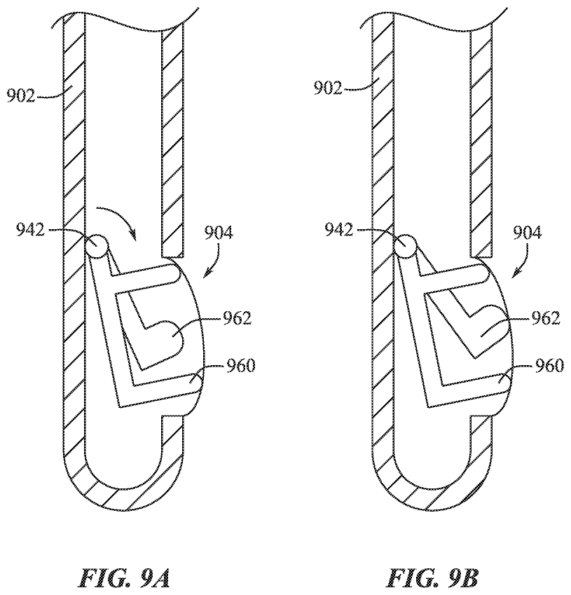

FIG. 8A shows a top view of a support arm 802 in a retracted position and FIG. 8B shows the support arm in an extended or expanded position. The support arm 802 can be substantially similar to, including some or all of the features of, the support arms described herein, such as support arm 102, 202, 302, 402, 502, 602, and 702. The support arm 802 can include an adjustable arm tip 804. In some examples, the arm tip 804 includes a bladder that defines a volume 866. The volume 866 can contain a liquid or gas. A sliding cam 842 can increase pressure within the volume 866 by sliding in a first direction to decrease the size of the volume 866 causing the arm tip 804 to expand outward toward the user's head. When the sliding cam 842 is slid in a second, opposite direction (e.g., away from the arm tip 804), the size of the volume 866 increased causing a drop in pressure and causing the arm tip 804 to partially deflate. In some examples, a catch or lock can secure the sliding cam 842 despite the pressurized fluid in the volume 866 pushing against the sliding cam 842. Actuation of the sliding cam 842 can result from manual input by a user, or can result from electrical signals to mechanically drive the sliding cam 842. In some examples, fluid is added to or withdrawn from the bladder 804 to expand, deflate, or otherwise adjust the bladder 804, respectively. Further details of example adjustment mechanisms are provided below with reference to FIGS. 9A and 9B.

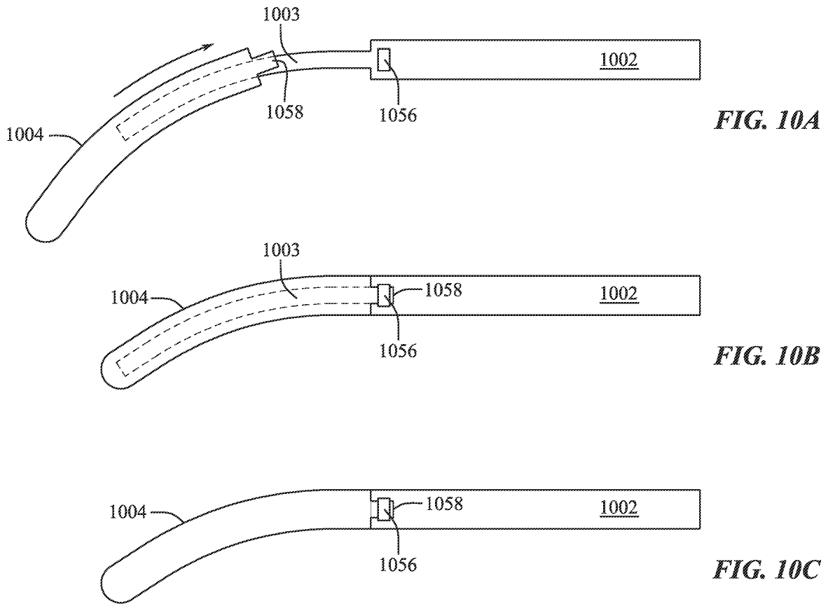

FIG. 9A shows a top view of a support arm 902 in a retracted position, and FIG. 9B shows the support arm in an extended or expanded position. The support arm 902 can be substantially similar to, including some or all of the features of, the support arms described herein, such as support arm 102, 202, 302, 402, 502, 602, 702, and 802. The support arm 902 can include an adjustable arm tip 904. In some examples, a plurality of ribs 960, 962 can adjustably support the arm tip 904, increasing and decreasing the stiffness and/or shape of the arm tip 904. A dial or knob 942 can rotate to adjust the presence and positioning of the ribs 960, 962. For example, a user can rotate the knob 942 in a first direction (e.g., clockwise) to retract at least one rib 962 from supporting the arm tip 904. By retracting the rib 962 the arm tip 904 becomes less stiff and may not extend as far toward the user's head. Similarly, if a user rotates the knob 942 in a second direction (e.g., counterclockwise), one or more ribs 962 extend to press against the arm tip 904 to increase stiffness and potentially expand the arm tip 904 toward the user's head. Actuation of the knob 942 can result from manual input by a user, or can result from electrical signals to mechanically rotate the knob 942. In some examples, the knob 942 can be replaced with a linear actuator. Further details of example customizable arm tips are provided below with reference to FIGS. 10A-10C.

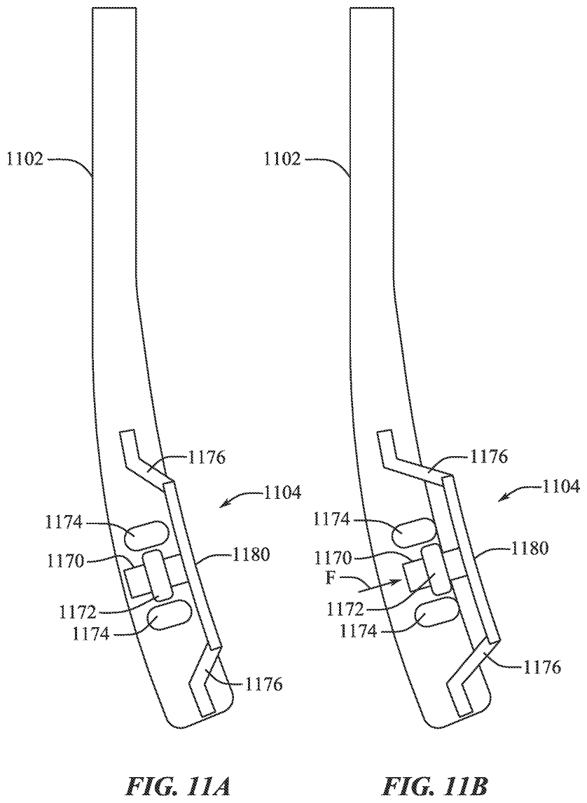

FIGS. 10A and 10B show a side view of a customizable support arm tip 1004 designed to be attached to a support arm 1002. The arm tip 1004 can include a plastic and/or rubber sleeve that slides over a tail portion 1003 of the support arm 1002. The support arm 1002 can be substantially rigid, while the tail portion 1003 can be flexible. In some examples, the arm tip 1004 includes shape memory material such as memory foam. In some examples, the arm tip 1004 is malleable and can be formed into a desired shape by the user. The support arm 1002 can include a coupler 1056 that is intended to couple with a tab 1058 on the arm tip 1004. Any number of coupling mechanisms could be used to secure the tab 1058 and the coupler 1056. For example, the tab 1058 could snap into place in the coupler 1056 to removably secure the arm tip 1004 to the support arm 1002. The thickness, length, material, and overall shape of the arm tip 404 can be selected and customized by a user to fit according to the user's preferences. For example, the arm tip 1004 can have a customized wrap angle, color, material, etc. In some examples, the arm tip 1004 can include electrical components that assist in operation of the smart glasses. FIG. 10C shows the arm tip 1004 being attached directly to the end of the support arm 1002. In other words, the tail portion 1003 of FIGS. 10A and 10B is not present in the embodiment of FIG. 10C, and the arm tip 1004 is supported on the support arm 1002 solely using tab 1058 and coupler 1056. Further details of example adjustment mechanisms are provided below with reference to FIGS. 11A and 11B.

FIG. 11A shows a top view of a support arm 1102 having an adjustable arm tip 1104. The support arm 1102 can be substantially similar to, including some or all of the features of, the support arms described herein. FIG. 11A shows the arm tip 1104 in a retracted position and FIG. 11B shows the arm tip 1104 in an extended position (i.e., with the arm tip 1104 extended toward a user's head when being worn by a user).

In some examples, the support arm 1102 includes an actuation device including magnets 1174 that interact with a wire coil 1172 to move a plunger 1170 which pushes the arm tip 1104 outward. The arm tip 1104 can include a flexible membrane or skirt 1176 that surrounds a perimeter of a plastic surface 1180 that contacts the user's head. In some examples, the arm tip 1104 includes a locking mechanism that locks the plunger 1170 in an extended configuration. The locking mechanism removes the need for the magnets 1174 and coil 1172 to continuously power the plunger 1170 in the extended configuration. The lock can then be released when input requires the arm tip 1104 to be in the retracted configuration.

The computer glasses described herein can be used in conjunction with a wide variety of computer based reality. For example, computer-generated reality (CGR) environment refers to a wholly or partially simulated environment that people sense and/or interact with via an electronic system. The glasses can be used in a mixed reality environment. In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects).

Personal information data can, but is not required to, be used with the various embodiments described herein, provided that the information has been gathered using authorized and well established secure privacy policies and practices.

It will be understood that the details of the present systems and methods above can be combined in various combinations and with alternative components. The scope of the present systems and methods will be further understood by the following claims.

What is claimed is:

1. A wearable electronic device, comprising:
a display; and
a support arm connected to the display, the support arm comprising:
a static portion connected to the display;
a dynamic portion connected to the static portion; and
an adjustment mechanism positioned in the dynamic portion and configured to change a thickness of the dynamic portion.

2. The wearable electronic device of claim 1, wherein:
the support arm comprises a first support arm, the static portion comprises a first static portion, the dynamic portion comprises a first dynamic portion, and the adjustment mechanism comprises a first adjustment mechanism;
the wearable electronic device further comprises a second support arm connected to the display, the second support arm comprising:
a second static portion connected to the display, the second static portion housing an electronic component;
a second dynamic portion positioned opposite the display at an end of the second support arm; and
a second adjustment mechanism positioned in the second dynamic portion and configured to change a thickness of the second dynamic portion.

3. The wearable electronic device of claim 2, wherein:
the first adjustment mechanism and the second adjustment mechanism each have a first state and a second state; and
a distance between the first adjustment mechanism and the second adjustment mechanism is greater in the second state than in the first state.

4. The wearable electronic device of claim 1, the adjustment mechanism further comprising:
a moveable member;
a first magnet engageable with the movable member in a first state; and
a second magnet engageable with the movable member in a second state.

5. The wearable electronic device of claim 1, the adjustment mechanism further comprising a mechanical actuator.

6. The wearable electronic device of claim 1, the adjustment mechanism further comprising an electrical actuator.

7. The wearable electronic device of claim 1, wherein:
a proximal end of the support arm is connected to the display; and
the adjustment mechanism is located at a distal end of the support arm.

8. The wearable electronic device of claim 1, wherein the adjustment mechanism is bi-stable.

9. The wearable electronic device of claim 1, further comprising a sensor configured to detect an amount of force exerted on an object by the adjustment mechanism.

10. A support arm, comprising:
a section including an electrical component; and
a movable section;
wherein the movable section is deformable to define a radius of curvature.

11. The support arm of claim 10, wherein the section is substantially rigid.

12. The support arm of claim 10, wherein the movable section comprises a plurality of vertebrae to maintain a minimum radius of the radius of curvature.

13. The support arm of claim 10, wherein the movable section comprises a deformable wire.

14. The support arm of claim 10, wherein the movable section comprises a variable volume bladder.

15. The support arm of claim 10, wherein the variable volume bladder is adjusted using at least one of pneumatics or hydraulics.

16. The support arm of claim 10, further comprising an external actuator configured to deform the movable section in response to a movement of the external actuator, the movement comprising at least one of a rotational motion or a translational motion.

17. The support arm of claim 10, further comprising an inertial measurement unit operatively coupled to the movable section, wherein the movable section is deformable in response to a signal from the inertial measurement unit.

18. A method for securing headwear to a head of a user, the method comprising:
receiving a command to tighten the headwear on the head;
activating an adjustment mechanism on a support arm of the headwear;
determining a force applied to the head by the support arm; and
modifying a state of the adjustment mechanism in response to the force meeting a predetermined threshold.

19. The method of claim 18, wherein activating the adjustment mechanism comprises modifying a density of the adjustment mechanism.

20. The method of claim 18, further comprising transmitting the command to tighten the headwear in response to a detected motion of the headwear.
